(19) United States
(12) Patent Application Publication
(10) Pub. No.: US 2016/0315787 A1
(43) Pub. Date: Oct. 27, 2016

(54) NETWORK SYSTEM, CONTROL DEVICES, CONTROL METHOD, AND PROGRAM

(71) Applicant: NEC Corporation, Minato-ku, Tokyo (JP)

(72) Inventor: Yasuhiro Miyao, Tokyo (JP)

(21) Appl. No.: 15/105,744

(22) PCT Filed: Dec. 16, 2014
(86) PCT No.: PCT/JP2014/083262

§ 371 Date: Jun. 17, 2016

(30) Foreign Application Priority Data
Dec. 18, 2013 (JP) 2013-261133

(51) Int. Cl. H04L 12/64; H04L 12/741; H04L 29/12; H04L 12/751

(52) U.S. Cl. CPC H04L 12/6418; H04L 45/02; H04L 45/745; H04L 61/6022

(57) ABSTRACT

A load applied to a forwarding system such as a switch or a link is reduced by restricting a range of broadcasting of an unset frame. A network system including a switch and a link connecting switches includes a plurality of first control apparatuses that are provided to a plurality of first domains respectively when the network system is divided into the plurality of first domains and control the switch included in the plurality of first domains respectively, and a second control apparatus that is provided to a second domain that is an aggregation of the plurality of first domains and controls the plurality of first control apparatuses. The plurality of first control apparatuses each include a database holding an address of a terminal and an identifier of a switch port accommodating the terminal associated with each other, the address of the terminal including an identifier of the first domain to which the switch accommodating the terminal to which the address is provided belongs, upon reception of a frame for which a path is not set from the switch included in an own domain of the first control apparatus, determine whether a destination address of the frame belongs to the own domain of the first control apparatus or not, and when the destination address does not belongs to the own domain of the first control apparatus, forward the frame to the second control apparatus.

### TECHNICAL FIELD

### Description of Related Application

This application is based upon and claims the benefit of priority from Japanese patent application: No. 2013-261133 (filed on Dec. 18, 2013), the disclosure of which is incorporated herein in its entirety by reference. The present invention relates to a control apparatus, a network system, a control method, and a program, and particularly to a network system including a plurality of domains, a control apparatus, a control method, and a program which perform a centralized path control in such a network system.

### BACKGROUND ART

In a packet switching network, in particular, in a connectionless L2 (Layer 2) network in which a switch to be forwarded next is determined based on a destination MAC (Media Access Control) address, path control is performed in the following manner (NPL 1). Hereinunder, a MAC address is also simply referred to as an “address”.

When the switch receives a frame which is a data transfer unit of L2 from another switch, the switch registers a pair of a transmission source address and a received switch port in a forwarding database (hereinafter, database (Database) is also referred to as “DB”). In order to enable high speed registration to the forwarding DB and high speed reference to the forwarding DB, the forwarding DB is generally implemented on a memory of a server machine.

The switch then refers to the forwarding DB when the switch receives a frame and determines a destination port. In cases in which, when the switch refers to the forwarding DB, a switch port which accommodates a destination terminal corresponding to a destination MAC address is not registered, the switch forwards (broadcasts) the received frame to all terminals connected to a network.

When broadcasting is performed in a network composed of a plurality of switches, a spanning tree protocol is used in order to prevent endless circulation of a broadcast caused by generation of a loop in a forwarding path. According to a spanning tree protocol, a minimum spanning tree for a given cost is generated by a distributed procedure using a certain switch as a root, and a frame is forwarded along the tree between adjacent switches.

On the other hand, as a path control method of an L2 network, a centralized control using an OpenFlow (OpenFlow) protocol described in NPL 6 different from the above-described distributed path control method is known (NPL 2).

According to the OpenFlow protocol, not only a path setting control but also a forwarding DB is managed in a centralized manner. A control apparatus (Controller: hereinafter, also referred to as “CTL”) receives an unset frame (specifically, a frame for which a matching condition for taking an action is not registered in a switch) from a switch which accommodates a transmission terminal. On the unset frame, an identifier (ID: Identifier) of a port which has received a frame is written by the switch which accommodates the transmission terminal. The control apparatus, referring to the unset frame, registers a combination of the ID of the switch port and transmission MAC address in the forwarding DB. Information registered in the forwarding DB is deleted when a period in which the information is not referred to exceeds a predetermined period.

Path setting herein deals with not a set of frames having the same destination MAC address but a set of frames having the same pair of transmission source and destination address.

Next, with reference to FIG. 16 and FIG. 17, network control based on OpenFlow will be described. Referring to FIG. 16, an L2 network includes a control apparatus 40, a forwarding DB 60, and switches (OpenFlow switches) A to J.

The OpenFlow switch A (here, departure switch) receives a frame from a transmission source terminal (step E1). When there is no flow which matches header information of the received frame, the OpenFlow switch A forwards an unset frame to the control apparatus 40 using a Packet In message (step E2). The Packet in message here includes the unset frame and an identifier of a switch port which has received the frame.

When the control apparatus 40 receives the unset frame, the control apparatus 40 registers a combination of a transmission source MAC address and the switch port which has received the unset frame in the forwarding DB 60.

Next, the control apparatus 40 refers to the forwarding DB 60 based on a destination MAC address in the Packet In message, and, when an output port of a corresponding switch can be resolved, calculates a path between a departure switch (in an example of FIG. 16, OpenFlow switch A) which has transmitted the Packet In and an arrival switch (in an example of FIG. 16, OpenFlow switch F) which is obtained by address resolution. Next, the control apparatus 40 instructs each switch on the path to set a flow including a header field representing a flow identification condition and an action (for example, forwarding to a specified port) specifying a process of a frame matching the header field, by using a Flow Mod message (step E3).

Next, the control apparatus 40 forwards the received unset flow to the arrival switch F by using a Packet Out message (step E4), and makes the arrival switch F transmit the unset flow from a specified port to a destination terminal (step E5).

On the other hand, as illustrated in FIG. 17, when an address is not resolved, the control apparatus 40 forwards (flooding) the frame to each switch by using a Minimum Spanning Tree (MST) which connects the control apparatus 40 and each switch (steps E6 and E7). Next, when each switch receives the frame, the switch forwards the frame to all terminals to which the switch is connected.

According to the centralized control as illustrated in FIG. 16 and FIG. 17, the control apparatus 40 performs path control between all terminals included in a network. Accordingly, when the number of terminals, the number of switches, and the number of links are increased, load of the control apparatus 40 increases, a time required for completion of a process is prolonged, and the process may not be completed normally.

For example, since, as the number of switches n increases, the number of pairs of departure switches and arrival switches for which a flow setting can be requested increases on the order of O(n²), the flow setting load by the control apparatus 40 increases.

On the other hand, as the number of switches n and the number of links e increase, a calculation amount of the control apparatus 40 for calculating a path increases. For example, according to a Dijkstra's algorithm, the calculation amount when the shortest path in which the number of links included in a path between certain switches is the smallest is O(e+n log n) (NPL 8).

As the number of terminals m increases, a storage amount of the forwarding DB 60 and an address retrieval time generally increase on the order of O(m). Accordingly, as the number of terminals increases, the size of a memory or processing speed of a CPU (Central Processing Unit) of a server machine for itself may reach its physical limit.

In order to deal with these problems, for example, NPL 3 describes a method of distributing a load of flow setting by layering a control apparatus. NPL 4 describes a method of distributing a load of flow setting by aggregating and layering domains and installing a control apparatus in each layer. The method described in NPL 4 will be described with reference to FIG. 18.

Referring to FIG. 18, the whole network is divided into three domains 31 to 33, and a domain 30 which is aggregation of the domains 31 to 33 is set. A control apparatus 40 on the upper layer includes a forwarding DB 60 which holds a MAC address. The control apparatus 40 holds an identifier of a switch which is connected to another lower domain among switches included in the lower domains and an identifier of a link which connects the switch with a switch included in another lower domain. The control apparatus 40 thus grasps the connection relationship between lower domains.

When the control apparatus 40 on the upper layer receives an unset frame from an edge switch A, the control apparatus 40 refers to the forwarding DB 60. When there is an entry corresponding to a destination MAC address of the unset frame in the forwarding DB 60 and a port of an arrival switch can be resolved, the control apparatus 40 determines a path between the lower departure domain 31 which accommodates a departure terminal and the lower arrival domain 33 which accommodates an arrival terminal. The control apparatus 40 may determine, for example, a path in which the number of hops is the smallest as a path between both the domains. The control apparatus 40 further determines a switch pair at a border of each lower domain, specifies the determined switch pair and a header field, and instructs control apparatuses 51 to 53 on the lower layer to perform flow setting.

When the control apparatuses 51 to 53 on the lower layer receive an instruction of flow setting, they determine a path between specified switches, and perform flow setting to each switch on the determined path. Here, the control apparatuses 51 to 53 on the lower layer may determine, for example, a path in which the number of hops is the smallest as a path between the specified switches.

Next, the control apparatus 40 on the upper layer sends out the previous unset frame received from the edge switch to the control apparatus 53 of the arrival domain 33. The control apparatus 53 on the lower layer further sends out the unset frame to the arrival switch F to forward to a reception terminal.

Since, at this time, the control apparatus 40 on the upper layer regards the lower layer as a virtual one node during path calculation, it is not necessary to take individual switches and links included in the network into consideration. It is therefore possible to reduce the calculation amount of path calculation by the control apparatus 40. A load of flow setting to a switch can be distributed to the control apparatuses on the lower layer, and therefore, a load of the control apparatus 40 on the upper layer is reduced.

### CITATION LIST

### Patent Literature

[PLT 1] WO 2012/108382 A
[PLT 2] WO 2013/026050 A
[PLT 3] JP 2013-522934 A1

### Non Patent Literature

[NPL 1] Radia Perlman, “Interconnections: Bridges, Routers, Switches, and Internetworking Protocols (2nd Edition),” pp. 47-59, Addison-Wesley Professional, 1999.
[NPL 2] L. Sun, K. Suzuki, Y. Suzuki, H. Shimonisi, “A Network Management Solution Based on OpenFlow Towards New Challenges of Multitenant Data Center,” Information and Telecommunication Technologies (APSITT), 2012 9th Asia-Pacific Symposium on. IEEE, 2012.
[NPL 3] H. Shimonishi, et al., “Building Hierarchical Switch Network Using OpenFlow,” Intelligent Networking and Collaborative Systems, 2009, INCOS'09, International Conference on. IEEE, 2009.
[NPL 4] Ashida, Koide, Shimonishi, “A hierarchical control method with domain aggregation on OpenFlow networks”, Technical report of IEICE, CQ, Communication Quality, 112(10), 35-40, 2012-04-12
[NPL 5] ATM Forum Technical Committee, “Private Network-Network Interface Specification Version 1.0 (PNNI 1.0),” af-pnni-0055.000, March 1996, [online], [retrieved on Nov. 15, 2013], Internet <URL: http://www.broadband-forum.org/ftp/pub/approved-specs/af-pnni-0055.000.pdf>.
[NPL 6] OpenFlow Switch Specification Version 1.3.1 (Wire Protocol 0x04) Sep. 6, 2012, [online], [retrieved on Nov. 15, 2013], Internet <URL: https://www.opennetworking.org/images/stories/downloads/sdn-resources/onf-specifications/openflow/openflow-spec-v1.3.1.pdf>.
[NPL 7] Wikipedia, the free encyclopedia, “MAC address,” [online], [retrieved on Nov. 15, 2013], Internet <URL: http://en.wikipedia.org/wiki/MAC_address#Address_details>.
[NPL 8] M. Barbehenn, “A Note on the Complexity of Dijkstra's Algorithm for Graphs with Weighted Vertices,” IEEE Transactions on Computers, Volume 47, Issue 2, February 1998, p. 263.

### SUMMARY OF INVENTION

### Technical Problem

The above-described patent literature and non patent literature are hereby incorporated by reference in their entirety. The following analysis has been done by the present inventor.

In a technique of layering a control system described in NPL 4, an unset frame is broadcasted to all terminals in lower domains other than a transmission terminal. According to the technique described in NPL 4, as the number of switches accommodating a terminal increases, a range in which an unset frame is transferred in a network expands. In this case, congestions occur due to an increase in a load applied to a switch or a link, and a deterioration in forwarding performance (delay of forwarding frames, increase in rejection rate, or the like) may be occurred.

Accordingly, it is demanded that a range of broadcasting of an unset frame is restricted to reduce a load applied to a forwarding system such as a switch or a link.

An object of the present invention is to provide a network system, a control apparatus, a control method, and a program contributing to such a demand.

### Solution to Problem

A network system according to first exemplary aspect of the present invention includes a switch and a link connecting switches. The network system includes: a plurality of first control apparatuses that are provided to a plurality of first domains respectively when the network system is divided into the plurality of first domains and control the switch included in the plurality of first domains respectively; and a second control apparatus that is provided to a second domain that is an aggregation of the plurality of first domains and controls the plurality of first control apparatuses, wherein the plurality of first control apparatuses each include a database holding an address of a terminal and an identifier of a switch port accommodating the terminal associated with each other, the address of the terminal including an identifier of the first domain to which the switch accommodating the terminal to which the address is provided belongs, upon reception of a frame for which a path is not set from the switch included in an own domain of the first control apparatus, determine whether a destination address of the frame belongs to the own domain of the first control apparatus or not, and when the destination address does not belongs to the own domain of the first control apparatus, forward the frame to the second control apparatus.

A control apparatus according to second exemplary aspect of the present invention is a first control apparatus that is provided to one of a plurality of first domains when a network system including a switch and a link connecting switches is divided into the plurality of first domains and controls the switch included in the first domain. The first control apparatus includes: a database holding an address of a terminal and an identifier of a switch port accommodating the terminal associated with each other, the address of the terminal including an identifier of the first domain to which the switch accommodating the terminal to which the address is provided belongs, wherein, the first control apparatus, upon reception of a frame for which a path is not set from the switch included in an own domain of the first control apparatus, determines whether a destination address of the frame belongs to the own domain of the first control apparatus or not, and when the destination address does not belongs to the own domain of the first control apparatus, forwards the frame to a second control apparatus that is provided to a second domain that is an aggregation of the plurality of first domains and controls the plurality of first control apparatuses.

A control apparatus according to third exemplary aspect of the present invention is a second control apparatus that is configured to control a plurality of first control apparatuses that are provided to a plurality of first domains respectively when a network system including a switch and a link connecting switches is divided into the plurality of first domains and control the switch included in the plurality of first domains respectively, and is provided to a second domain that is an aggregation of the plurality of first domains, wherein the plurality of first control apparatuses each include a database holding an address of a terminal and an identifier of a switch port accommodating the terminal associated with each other, the address of the terminal including an identifier of the first domain to which the switch accommodating the terminal to which the address is provided belongs, upon reception of a frame for which a path is not set from the switch included in an own domain of the first control apparatus, determine whether a destination address of the frame belongs to the own domain of the first control apparatus or not, and when the destination address does not belongs to the own domain of the first control apparatus, forward the frame to the second control apparatus.

A control method according to fourth exemplary aspect of the present invention is for a first control apparatus that is provided to one of a plurality of first domains when a network system including a switch and a link connecting switches is divided into the plurality of first domains and controls the switch included in the first domain. The method includes a step of holding an address of a terminal and an identifier of a switch port accommodating the terminal associated with each other, the address of the terminal including an identifier of the first domain to which the switch accommodating the terminal to which the address is provided belongs; a step of determining, upon reception of a frame for which a path is not set from the switch included in an own domain of the first control apparatus, whether a destination address of the frame belongs to the own domain of the first control apparatus or not; and a step of forwarding, when the destination address does not belongs to the own domain of the first control apparatus, the frame to a second control apparatus that is provided to a second domain that is an aggregation of the plurality of first domains and controls the plurality of first control apparatuses.

A program according to fifth exemplary aspect of the present invention is performed by a first control apparatus that is provided to one of a plurality of first domains when a network system including a switch and a link connecting switches is divided into the plurality of first domains and controls the switch included in the first domain. The program causes the first control apparatus to perform: a process of holding an address of a terminal and an identifier of a switch port accommodating the terminal associated with each other; a process of determining, upon reception of a frame for which a path is not set from the switch included in an own domain of the first control apparatus, whether a destination address of the frame belongs to the own domain of the first control apparatus or not; and a process of forwarding, when the destination address does not belongs to the own domain of the first control apparatus, the frame to a second control apparatus that is provided to a second domain that is an aggregation of the plurality of first domains and controls the plurality of first control apparatuses, wherein the address of the terminal including an identifier of the first domain to which the switch accommodating the terminal to which the address is provided belongs.

A program can be provided as a program product recorded on a non-transitory computer-readable storage medium.

### Advantageous Effects of Invention

By a network system, a control apparatus, a control method, and a program according to the present invention, it is possible to reduce a load applied to a forwarding system such as a switch or a link by restricting a range of broadcasting of an unset frame.

### BRIEF DESCRIPTION OF DRAWINGS

FIG. 1 is a diagram illustrating one example of configuration of a network system according to a first exemplary embodiment.

FIG. 2 is a block diagram illustrating one example of a configuration of a control apparatus which is installed in a domain other than the lowest domain in the first exemplary embodiment.

FIG. 3 is a block diagram illustrating one example of a configuration of a control apparatus which is installed in the lowest domain in the first exemplary embodiment.

FIG. 4 is a flow diagram illustrating one example of an operation of a control apparatus which is installed in a domain other than the lowest domain in the first exemplary embodiment.

FIG. 5 is a flow diagram illustrating one example of an operation of a control apparatus which is installed in a domain other than the lowest domain in the first exemplary embodiment.

FIG. 6 is a flow diagram illustrating one example of an operation of a control apparatus which is installed in the lowest domain in the first exemplary embodiment.

FIG. 7 is a flow diagram illustrating one example of an operation of a control apparatus which is installed in the lowest domain in the first exemplary embodiment.

FIG. 8 is a flow diagram illustrating one example of an operation of a control apparatus which is installed in a domain other than the lowest domain in a second exemplary embodiment.

FIG. 9 is a flow diagram illustrating one example of an operation of a control apparatus which is installed in the lowest domain in the second exemplary embodiment.

FIG. 10 is a flow diagram illustrating one example of an operation of a control apparatus which is installed in the lowest domain in the second exemplary embodiment.

FIG. 11 is a diagram illustrating an Example (Example 1) of the first exemplary embodiment.

FIG. 12 is a diagram illustrating an Example (Example 1) of the first exemplary embodiment.

FIG. 13 is a diagram illustrating another Example (Example 2) of the first exemplary embodiment.

FIG. 14 is a diagram illustrating an Example (Example 3) of the second exemplary embodiment.

FIG. 15 is a diagram illustrating another Example (Example 4) of the second exemplary embodiment.

FIG. 16 is a diagram illustrating network control based on OpenFlow.

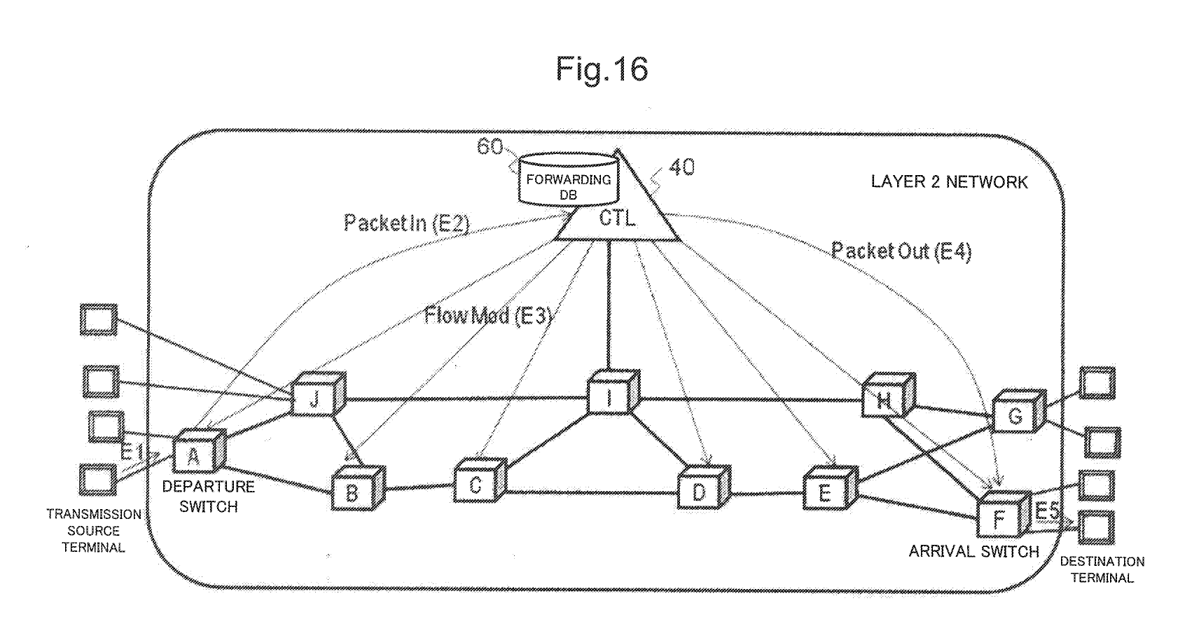

FIG. 17 is a diagram illustrating network control based on OpenFlow.

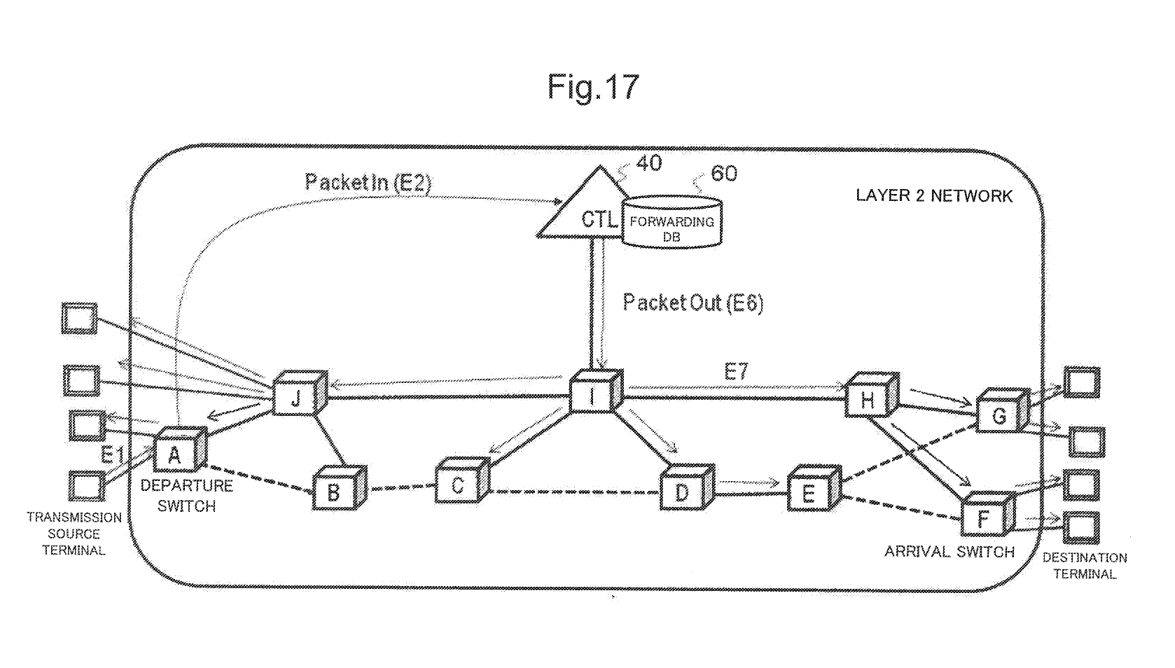

FIG. 18 is a diagram illustrating network control based on OpenFlow.

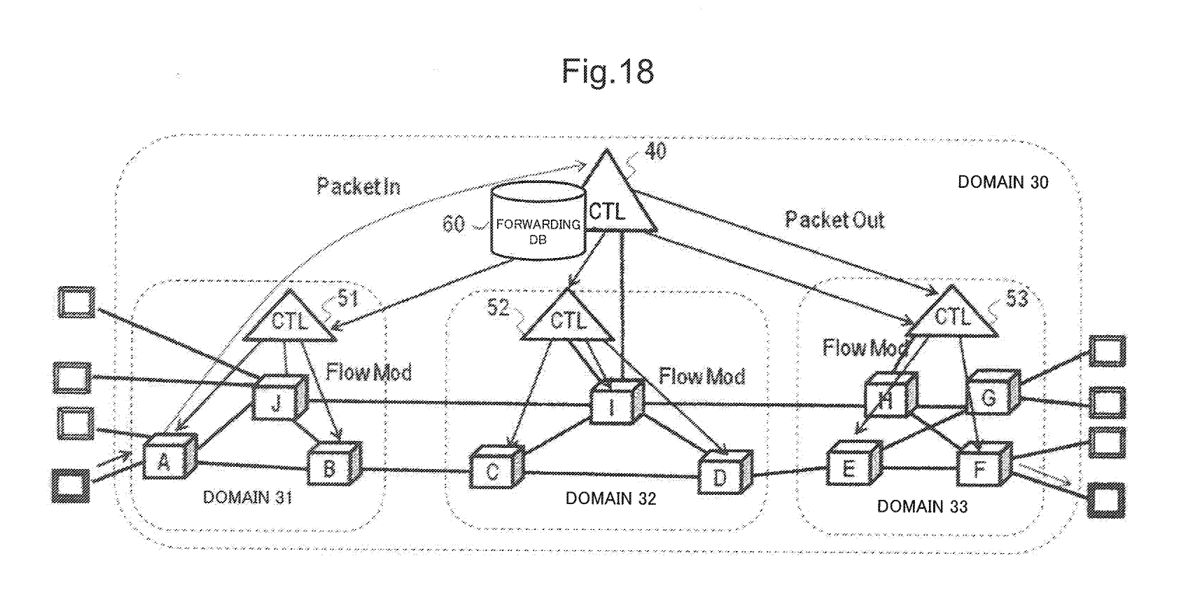

### DESCRIPTION OF EMBODIMENTS

First, an outline of one exemplary embodiment will be described. Reference numerals denoted in the outline are merely examples to help understanding, and do not intend that the present invention is limited to the illustrated mode.

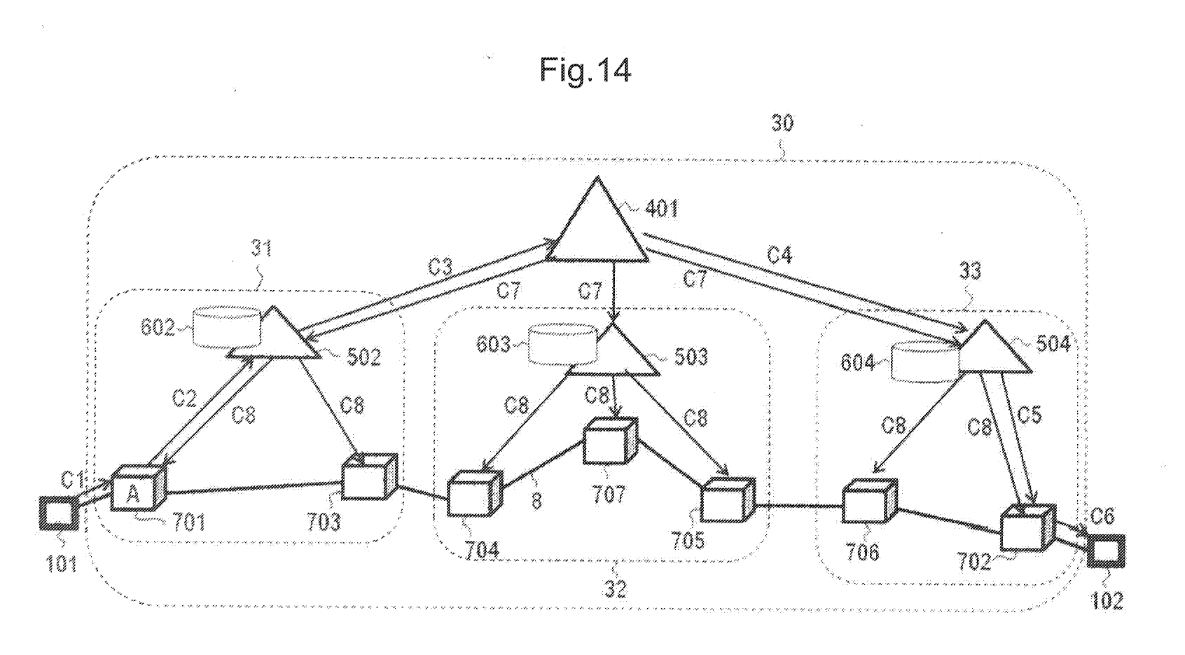

FIG. 14 is a diagram illustrating a configuration of a network system according to one exemplary embodiment. Referring to FIG. 14, the network system includes switches (701 to 707) and a link (8) connecting the switches. The network system further includes: first control apparatuses (502 to 504) which are provided to a plurality of first domains (31 to 33), respectively, into which the network system is divided and which control a switch included in the first domains, respectively; and a second control apparatus (401) which is provided to a second domain (30) which is an aggregation of the first domains (31 to 33) and which controls the first control apparatuses (502 to 504).

An address of a terminal (for example, a terminal 101) includes an identifier of a first domain (31) to which a switch (701) accommodating the terminal to which the address is provided belongs. Further, the first control apparatus (for example, the control apparatus 502) includes: a database (602) which holds an address of a terminal (101); and an identifier of a switch port which accommodates the terminal, associated with each other. Upon reception of a frame for which a path is not set from a switch included in its own domain, the first control apparatus (502 to 504) determines whether a destination address of the frame is its own domain, and when the destination address is not its own domain, the apparatus forwards the frame to the second control apparatus (401).

Further, the first control apparatus (502 to 504), when the destination address of the frame is its own domain and a switch port of forwarding destination of the frame cannot be resolved from the destination address based on the database (602 to 604), forwards the frame to a switch included in its own domain.

Upon reception of the frame from the first control apparatus (502 to 504), the second control apparatus (401) identifies an arrival domain (for example, the domain 33) of the frame based on the destination address of the frame, forwards the frame to the first control apparatus (504) provided in the identified arrival domain (33), and at the same time, determines a path between a first domain (for example, the domain 31) corresponding to a departure domain identified based on a transmission source address of the frame and the first domain (33) corresponding to the arrival domain, and instructs the first control apparatuses (502 to 504) provided to the first domains (31 to 33) on the determined path to perform path setting.

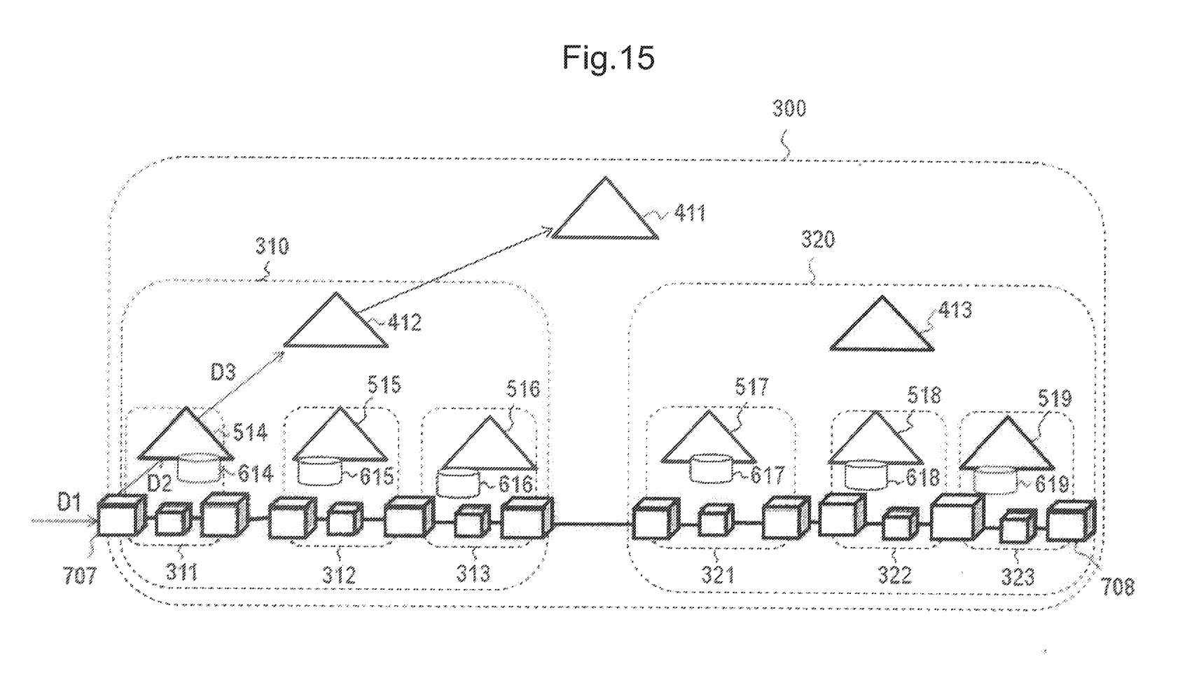

FIG. 15 is a diagram illustrating another configuration of a network system according to one exemplary embodiment. Referring to FIG. 15, the network system includes a third control apparatus (411) which is provided to a third domain (300) which is an aggregation of second domains (310, 320) and which controls second control apparatuses (412, 413). Here, upon reception of the frame from a first control apparatus (514 to 516, 517 to 519), the second control apparatus (412, 413) identifies an arrival domain of the frame based on a destination address of the frame, determines whether the identified arrival domain belongs to its own domain or not, and when the identified arrival domain does not belong to its own domain, forwards the frame to the third control apparatus (411).

Upon reception of the frame from the second control apparatus (412, 413), the third control apparatus (411) identifies an arrival domain (for example, a domain 323) of the frame based on the destination address of the frame, forwards the frame to the second control apparatus (413) provided to the domain (32) to which the identified arrival domain (323) belongs, and at the same time, determines a path between a second domain (310) to which a departure domain (for example, a domain 311) identified based on a transmission source address of the frame belongs and the second domain (320) to which the arrival domain (323) belongs, and instructs the second control apparatuses (412, 413) provided to the second domains (310, 320) on the determined path to perform path setting.

As described above, in another exemplary embodiment, a network is divided into domains, a plurality of domains in the same layer are aggregated to form a domain in the upper layer, and an identifier is provided to each domain and a control apparatus is installed in each domain. An address of a terminal includes a lowest domain identifier. In a control apparatus of a domain in the lowest layer, a database in which an address and position information of a terminal in the domain are registered is installed. A control apparatus in the lowest layer, when a position cannot be resolved from an address of a terminal, forwards an unset frame to a control apparatus in the upper layer. A control apparatus refers to a destination address of the unset frame, and when an arrival domain is not included in its own domain, forwards the unset frame to a control apparatus of upper layer, and on the other hand, when the arrival domain is included in its own domain, determines a path between the departure/arrival domains, and instructs each control apparatus on the path to perform path setting by specifying a switch pair.

As described above, by including an identifier identifying a domain in an address of a terminal (for example, setting part of bits in a bit string representing an address to be bits for identifying the domain), a range of broadcasting an unset frame can be restricted in an arrival domain, and a load applied to a forwarding system such as a switch or a link can be reduced.

### Exemplary Embodiment 1

A network system according to a first exemplary embodiment will be described in detail with reference to drawings.

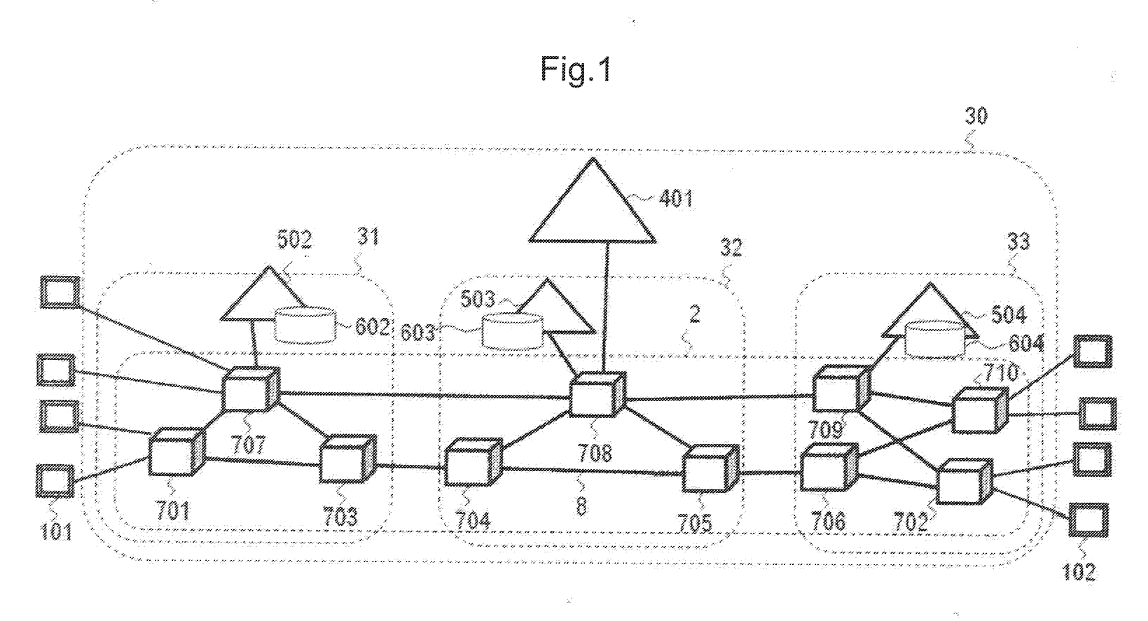

FIG. 1 is a diagram illustrating one example of configuration of a network system according to the present exemplary embodiment. Referring to FIG. 1, the network system includes a terminal 101, switches 701 to 710, a link 8, a control apparatus (CTL: Controller) 4, and a lowest control apparatus 5. The link 8 between the switches may be a physical link or may be a virtual path such as an MPLS (Multi-Protocol Label Switching).

Next, a method of configuring a multi-layered network system will be described.

First, a forwarding network 2 composed of the switches 701 to 710 and the link 8 is divided into a plurality of lowest domains. In FIG. 1, the forwarding network 2 is divided into three domains 31 to 33. The lowest domains 31 to 33 are aggregated to configure a domain 30 in the upper layer.

In these domains, a control apparatus 401 or lowest control apparatuses 502 to 504 are installed, respectively. In FIG. 1, the control apparatus 401 is installed in the domain 30 in the upper layer. On the other hand, in the lowest layer domains 31 to 33, the lowest control apparatuses 502 to 504 are installed respectively.

As described above, by performing aggregation of domains recursively (N times) until the number of domains becomes one, a multi-layered (N+1 layers) path control system is configured.

Here, examples of the domain in the lowest layer include a network in a data center accommodating a large number of server machines and data storages, and a wide-area network connecting different data centers.

In each domain, a domain identifier which identifies the domain is provided. By referring to the domain identifier, the control apparatus 4 can determine whether the domain is included in its own domain or not. As a method for attaining this, for example, the following two methods may be considered.

As a first method, a method like a conventional telephone numbering system in which domain identifiers are provided in a layered manner and in which a domain identifier in an upper layer and a domain identifier in a lower layer have a number field in common at high order bits is considered. As an example of such a multi-layer, PNNI (Private Network to Network Interface) defined in ATM (Asynchronous Transfer Mode) forum is described in NPL 5.

As a second method, a method in which an adjacent control apparatus DB 15 described below holds all identifiers of the lowest domain included in its own domain is considered.

In the following, description will be made based on the first method, but the present invention is not limited to such a method.

To the control apparatuses 502 to 504 in the lowest layer, a minimum spanning tree (MST: Minimum Spanning Tree) having a control apparatus in the lowest layer as a root is set in order to efficiently perform flooding of an unset frame from each control apparatus to all switches included in the domain. For example, a spanning tree including the minimum number of total links may be employed.

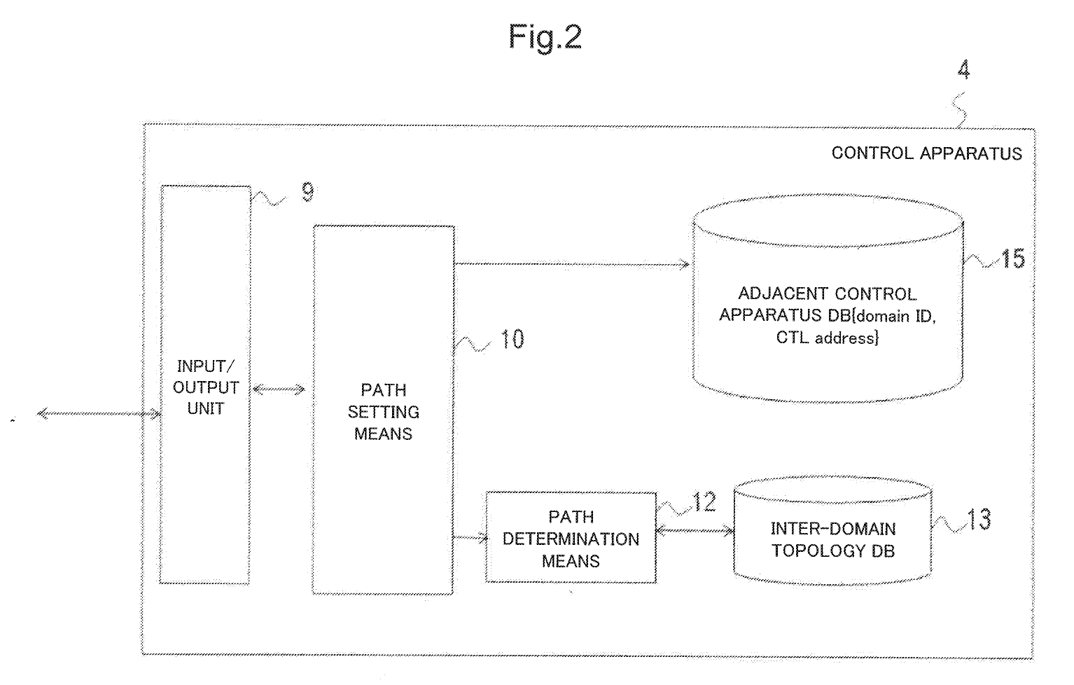

FIG. 2 is a block diagram illustrating one example of a configuration of the control apparatus 4 (for example, the control apparatus 401 of FIG. 1) installed in the domain in a higher layer than the lowest domain. Referring to FIG. 2, the control apparatus 4 includes an input/output unit 9, a path setting means 10, a path determination means 12, an adjacent control apparatus DB 15, and an inter-domain topology DB 13.

The input/output unit 9 functions as a communication interface for another control apparatus or a switch, takes out a message from communication data received from another control apparatus or a switch, and passes the message to the path setting means 10. The input/output unit 9 prepares communication data for transmitting a message generated by the path setting means 10 to another control apparatus or a switch.

The path setting means 10, when a departure domain identifier included in a received address resolution response is included in its own domain, makes the path determination means 12 calculate a path. The path setting means 10 instructs each lower control apparatus installed in the lower domain on the path to perform path setting based on the calculated path.

Further, upon reception of the unset frame information, the path setting means 10 forwards the received unset frame information to all adjacent control apparatuses other than a control apparatus which is a transmission source of the unset frame.

The unset frame information includes an unset frame, a header field representing a matching condition of flow, a departure domain identifier, an arrival domain identifier (when it is not resolved, a wild card is specified), and an identifier of a switch port which has received the unset frame.

On the other hand, the address resolution response includes a header field included in the received unset frame information, a departure domain identifier, an arrival domain identifier (when it cannot be resolved, a wild card is specified).

The inter-domain topology DB 13 holds information on a domain in a layer lower than own domain by one level. Specifically, the inter-domain topology DB 13 holds information on a border switch which is in contact with another domain, an external link connecting border switches, and an internal link connecting border switches in the domain.

Information held in the inter-domain topology DB 13 is updated by collecting information on a border switch in a lower domain, an external link between domains, and a logical internal link connecting border switches in the lower domain from the control apparatus in the lower layer.

The path determination means 12 determines a path between border switches specified by a control apparatus in the upper layer based on data stored in the inter-domain topology DB 13. A path to be determined is described, for example, as a list of identifiers of the border switches.

The path determination means 12 may, for example, determine a path in which the sum of costs each provided to an external link and an internal link in the lower layer domain is the lowest based on Dijkstra's algorithm.

The adjacent control apparatus DB 15 holds an ID of the lower domain, an address of the control apparatus installed in the lower domain, and ID of the upper layer domain, an address of the control apparatus installed in the upper layer.

The path setting means 10 sets a flow to switches on a path which the path determination means 12 outputs for the received unset flow.

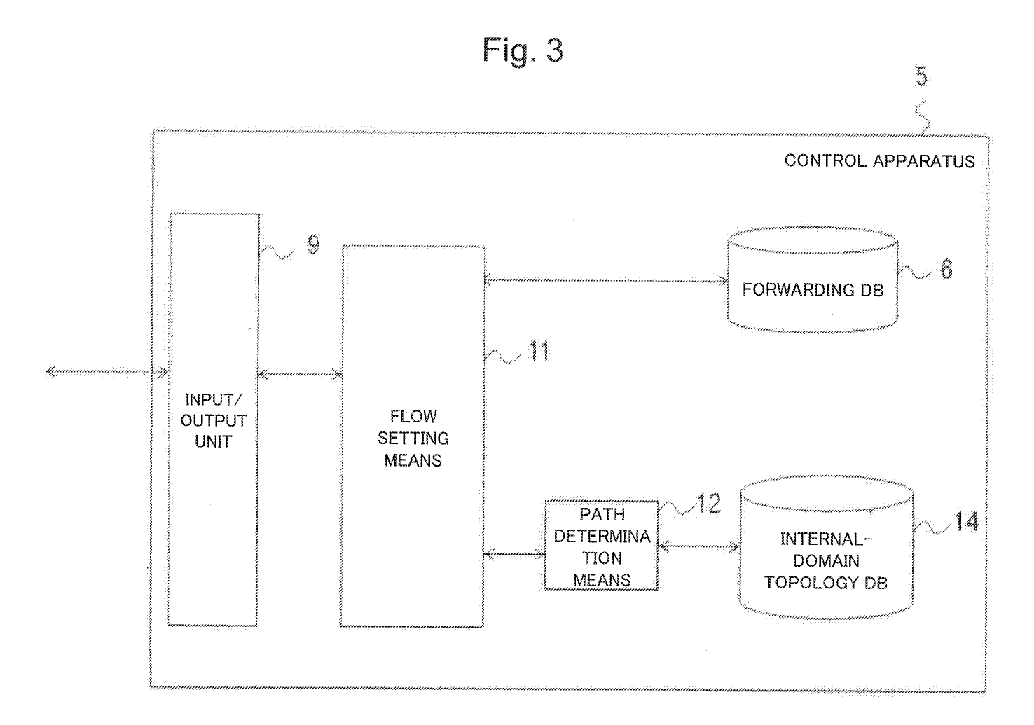

FIG. 3 is a block diagram illustrating one example of a configuration of a control apparatus 5 provided to the domain of the lowest layer. Referring to FIG. 3, the control apparatus 5 includes an input/output unit 9, a flow setting means 11, the path determination means 12, an internal-domain topology DB 14, and a forwarding DB 6.

The internal-domain topology DB 14 holds information on a switch and a link connecting switches. Such information is appropriately updated, for example, by using an LLDP (Link Layer Discovery Protocol) described in NPL 2. However, the present invention is not limited to such an update of information based on LLDP.

The forwarding DB 6 stores a MAC address and IDs of a switch and a port which accommodate a transmission source terminal of a frame including the MAC address as a transmission MAC address.

Next, an operation of the network system according to the present exemplary embodiment will be described in detail with reference to drawings.

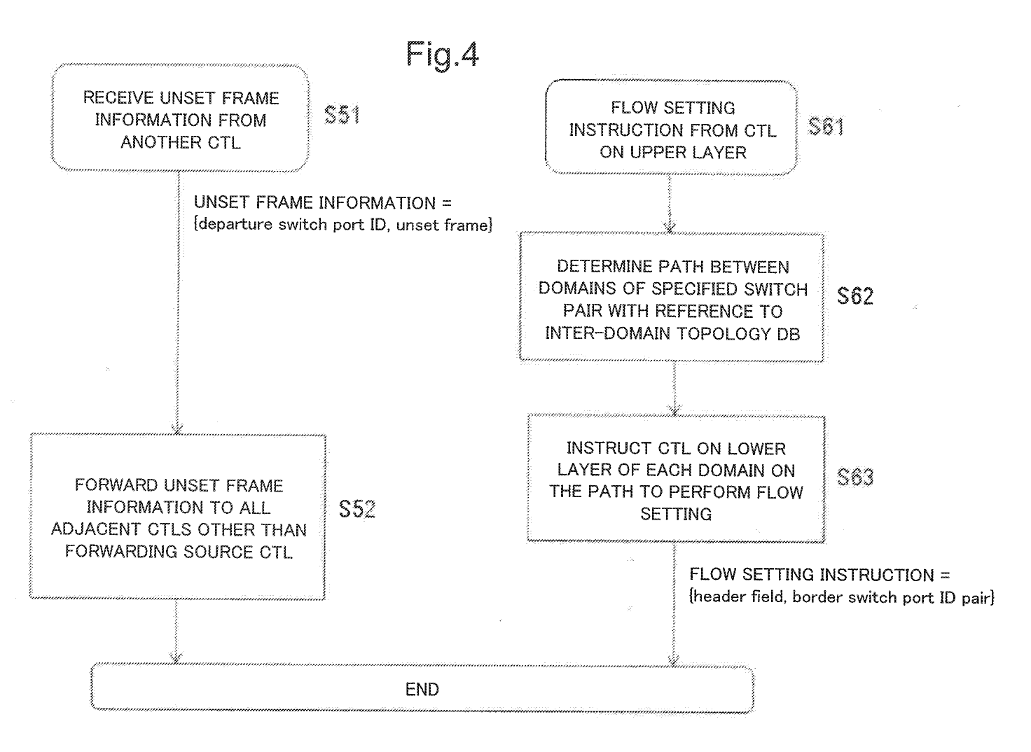

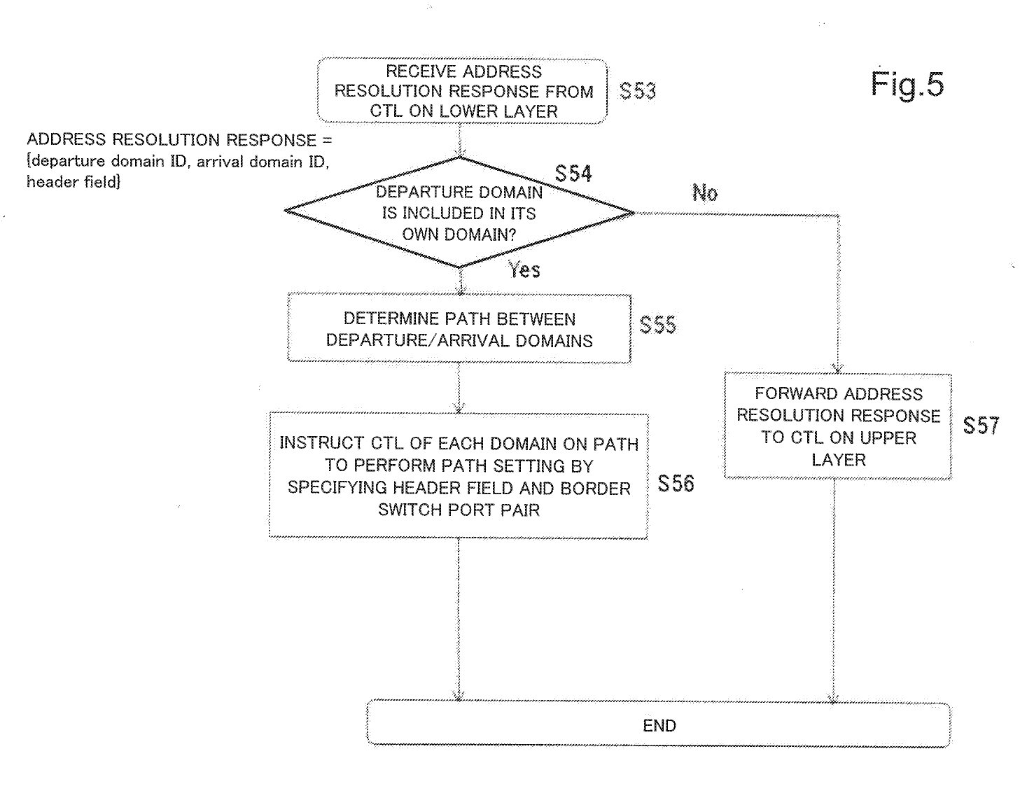

FIG. 4 and FIG. 5 are flow diagrams illustrating one example of an operation of the control apparatus 4 (FIG. 2) installed in the domain other than the lowest layer.

Referring to FIG. 4, the control apparatus 4, when the unset frame information is received from the control apparatus of a lower layer (step S51), transmits the received unset frame information to all adjacent control apparatuses other than the control apparatus provided to a departure domain (step S52).

Referring to FIG. 5, the control apparatus 4, when the address resolution response is received from the control apparatus in a lower layer (step S53), examines whether the departure domain included in the address resolution response is included in its own domain (step S54).

A control apparatus which is the transmission source of the address resolution response or the control apparatus in its lower layer is included in its own domain as an arrival domain. Therefore, when a departure domain is included in its own domain (Yes in step S54), both the departure domain and the arrival domain are included in its own domain. In this case, the control apparatus 4 knows topology information for path setting.

The control apparatus 4 then refers to the inter-domain topology DB 13, and determines a path between departure/arrival domains and a border switch pair in each domain on the path (step S55). Further, the control apparatus 4 instructs the control apparatus of each domain included in the path to perform path setting by specifying the border switch port and the header field included in the address resolution response (step S56).

On the other hand, the control apparatus 4, when the departure domain is not included in its own domain (No in step S54), forwards the address resolution response to the control apparatus of the upper layer (step S57).

Referring to FIG. 4, the control apparatus 4, when the flow setting instruction is received from the control apparatus of the upper layer (step S61), refers to the inter-domain topology DB 13, and determines the path between the specified switch pair (step S62). Next, the control apparatus 4 instructs the control apparatus of each domain included in the determined path to perform flow setting by specifying the switch pair (step S63).

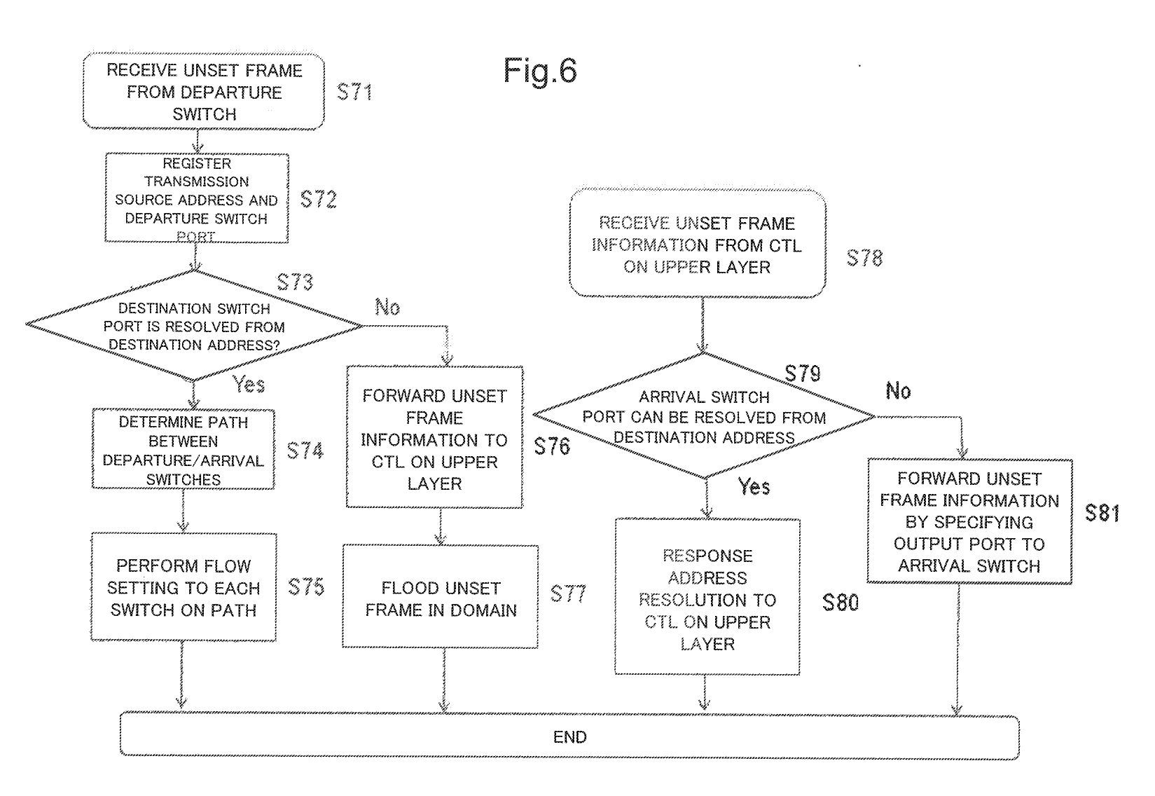

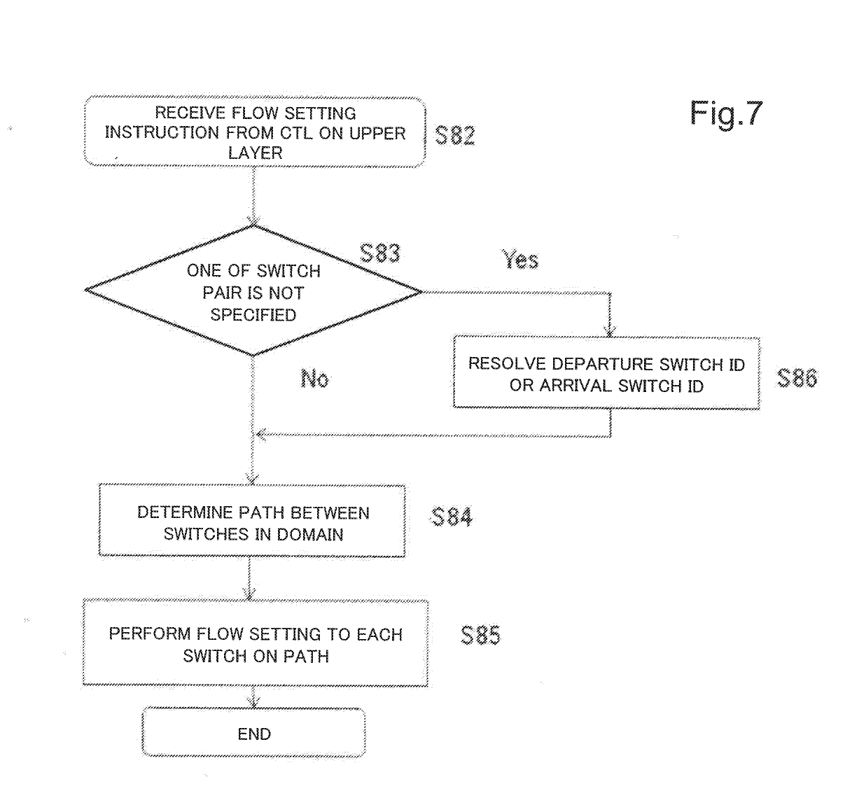

FIG. 6 and FIG. 7 are flow diagrams illustrating one example of an operation of the control apparatus 5 (FIG. 3) provided to the lowest layer.

Referring to FIG. 6, the control apparatus 5, when the unset frame is received from the departure switch (step S71), registers a pair of a transmission source address of the unset frame and a port from which the departure switch has received the unset frame in the forwarding DB 6 (step S72).

Next, the control apparatus 5 refers to the forwarding DB 6, and examines whether the switch port accommodating a terminal including the destination address can be resolved or not (step S73).

When the switch port can be resolved (Yes in step S73), the control apparatus 5 refers to the internal-domain topology DB 14, and determines a path between departure/arrival switches (step S74). Next, the control apparatus 4 performs flow setting on each switch on the path (step S75).

On the other hand, when the switch port cannot be resolved (No in step S73), the control apparatus 5 transmits the unset frame information to the control apparatus of the upper layer (step S76). Next, the control apparatus 5 instructs flooding of the unset frame in its domain on a minimum spanning tree which is set from the switch port connected to the control apparatus 5 to another switch (step S77). By this, the unset frame is forwarded ahead of each switch to all ports other than the reception port of the unset frame of the departure switch.

The control apparatus 5, when the unset frame information is received from the control apparatus in the upper layer (step S78), refers to the forwarding DB 6, and examines whether the switch port can be resolved from the received MAC address or not (step S79).

The control apparatus 5, when the switch port can be resolved from the received MAC address (Yes in step S79), transmits the address resolution response on which an arrival domain ID is written to the control apparatus in the upper layer (step S80).

On the other hand, when the switch port cannot be resolved from the received MAC address (No in step S79), the control apparatus 5 forwards the unset frame information to the arrival switch by specifying an output port (step S81).

Referring to FIG. 7, the control apparatus 5, when the instruction to perform flow setting by specifying the switch pair is received from the control apparatus in the upper layer (step S82), examines whether the border switch is unspecified or not (step S83).

When the border switch is specified (No in step S83), the control apparatus 5 proceeds to step S84. On the other hand, when the border switch is not specified (Yes in step S83), the control apparatus 5 refers to the forwarding DB 6 and resolves the identifier of the departure switch or the identifier of the arrival switch from the header field (step S86), and proceeds to step S84.

Next, the control apparatus 5 refers to the internal-domain topology DB 14, and determines the path between the switch pair in the domain (step S84). The control apparatus 5, for example, determines the path in which the sum of the number of links between switches is the smallest based on Dijkstra's algorithm. However, a method of determining the path in the present invention is not limited to such a method.

Next, the control apparatus 5 set a flow to each switch on the path (step S85).

In the present exemplary embodiment, a network is divided into a plurality of domains to be layered, and the forwarding database is installed in the control apparatus of the lowest layer which directly performs flow setting to a switch. This makes it possible to reduce a time required for address retrieving by the control apparatus of the upper layer and the storage amount of the forwarding DB. When an address can be resolved by the control apparatus of the lowest domain which directly performs flow setting to the switch, the unset frame is not forwarded to the upper control apparatus, and therefore, it is possible to reduce a load applied to the upper control apparatus.

### Exemplary Embodiment 2

Next, a network system according to a second exemplary embodiment will be described in detail with reference to drawings.

A configuration of the network system of the present exemplary embodiment is similar to the configuration (FIG. 1) of the network system of the first exemplary embodiment. In the present exemplary embodiment, a configuration of the control apparatus installed in the domain other than the lowest domain is similar to the configuration (FIG. 2) of the control apparatus installed in the domain other than the lowest domain in the first exemplary embodiment. Further, in the present exemplary embodiment, a configuration of the control apparatus installed in the lowest domain is similar to the configuration (FIG. 3) of the control apparatus installed in the lowest domain in the first exemplary embodiment.

In the present exemplary embodiment, unlike the first exemplary embodiment, the local address is used as a MAC address. A method of allocating bits in this case is described, for example, in NPL 7. In the present exemplary embodiment, the domain identifier identifying the domain is included in a MAC address. In this case, the control apparatus, by referring to a MAC address, can know the domain accommodating a terminal to which the MAC address is provided.

In the present exemplary embodiment, unlike the first exemplary embodiment, the path setting means 10 provided to the control apparatus 4 (FIG. 2), when the identified arrival domain is included in its own domain, makes the path determination means 12 calculate a path based on the destination address included in the received unset frame information. By using the calculation result of the path, the path setting means 10 instructs the control apparatus installed in each lower domain on the path to perform path setting.

Further, in the present exemplary embodiment, the unset frame information includes an unset frame, a header field representing a matching condition of flow, and an identifier of a switch port which has received the unset frame.

In the present exemplary embodiment, since the address includes the domain identifier unlike the first exemplary embodiment, it is not necessary to include the departure domain identifier and the arrival domain identifier in the unset frame information like in the first exemplary embodiment.

Unlike the first exemplary embodiment, the control apparatus 4 installed in the domain other than the lowest domain, when the arrival domain is not included in its own domain, forwards the unset frame information to the control apparatus in the upper layer.

In the following, an operation of the network system according to the present exemplary embodiment will be described in detail with reference to drawings.

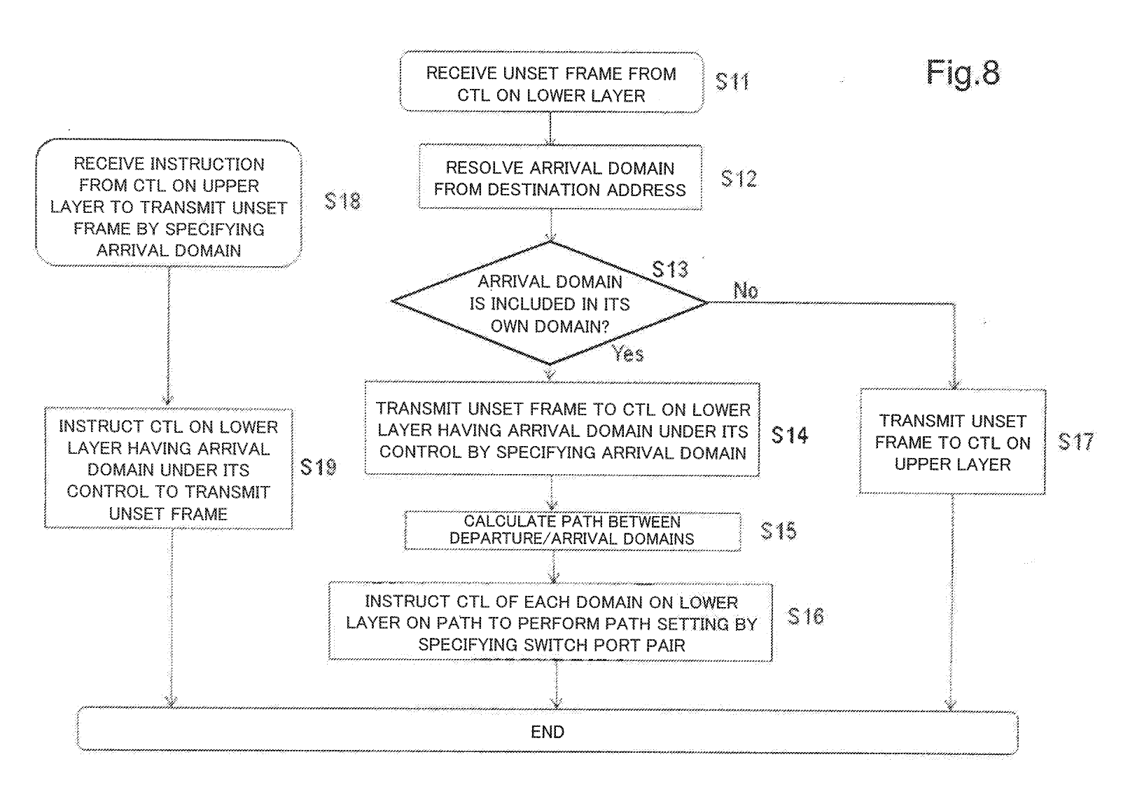

FIG. 8 is a flow diagram illustrating one example of an operation of the control apparatus 4 (FIG. 2) installed in the domain other than the lowest domain.

Referring to FIG. 8, the control apparatus 4, when the unset frame information is received from the control apparatus in the lower layer (step S11), resolves the arrival domain by referring to the destination MAC address (step S12).

Next, the control apparatus 4 examines whether the arrival domain is included in its own domain or not (step S13).

The control apparatus 4, when the arrival domain is included in its own domain (Yes in step S13), forwards the unset frame information to the control apparatus in the lower layer having the arrival domain under control by specifying the arrival domain (step S14).

Next, the control apparatus 4 calculates the path between the departure/arrival domains determined in step S12 by referring to the inter-domain topology DB (step S15), and determines the border switch of each domain and the port accommodating the link between domains.

Next, the control apparatus 4 instructs the control apparatus in the lower layer installed in each domain on the path to perform path setting by specifying the pair of border switch ports and the header field (step S16).

On the other hand, when the arrival domain is not included in its own domain (No in step S13), the control apparatus 4 forwards the unset frame information to the upper control apparatus (step S17).

The control apparatus 4, when the instruction to transmit the unset frame information by specifying the arrival domain is received from the control apparatus in the upper layer (step S18), instructs the control apparatus in the lower layer having the arrival domain under control to transmit the unset frame information (step S19).

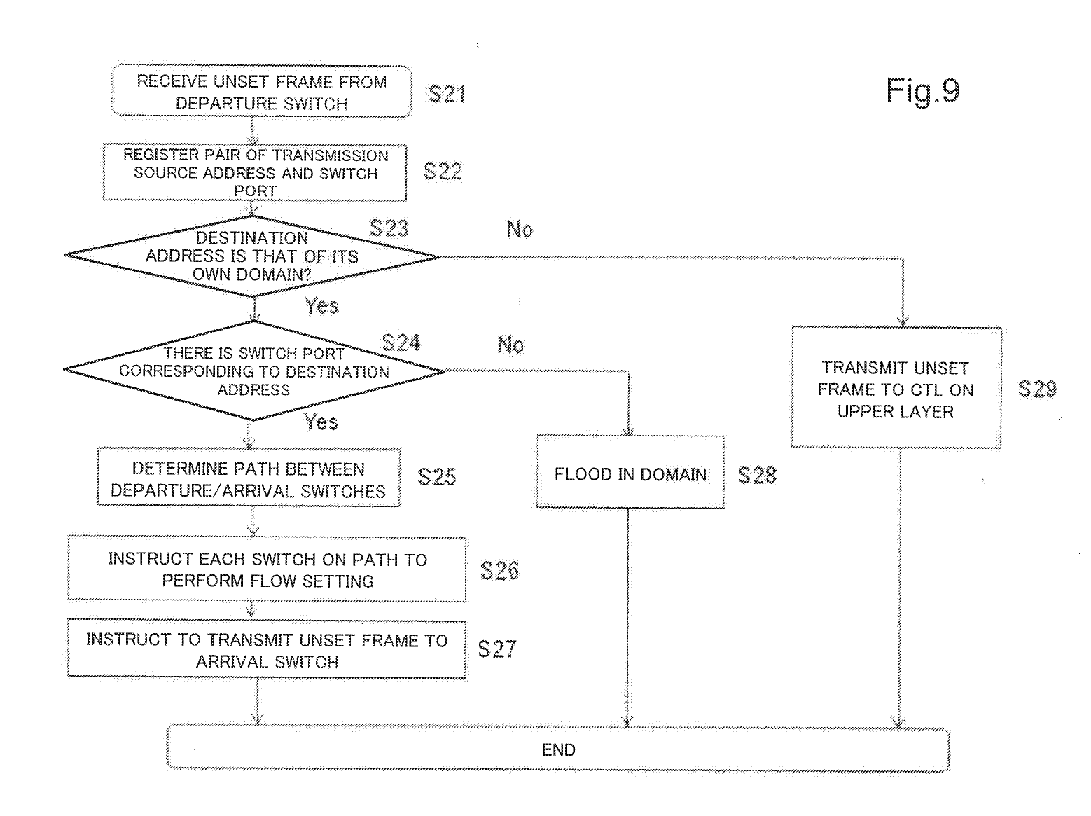

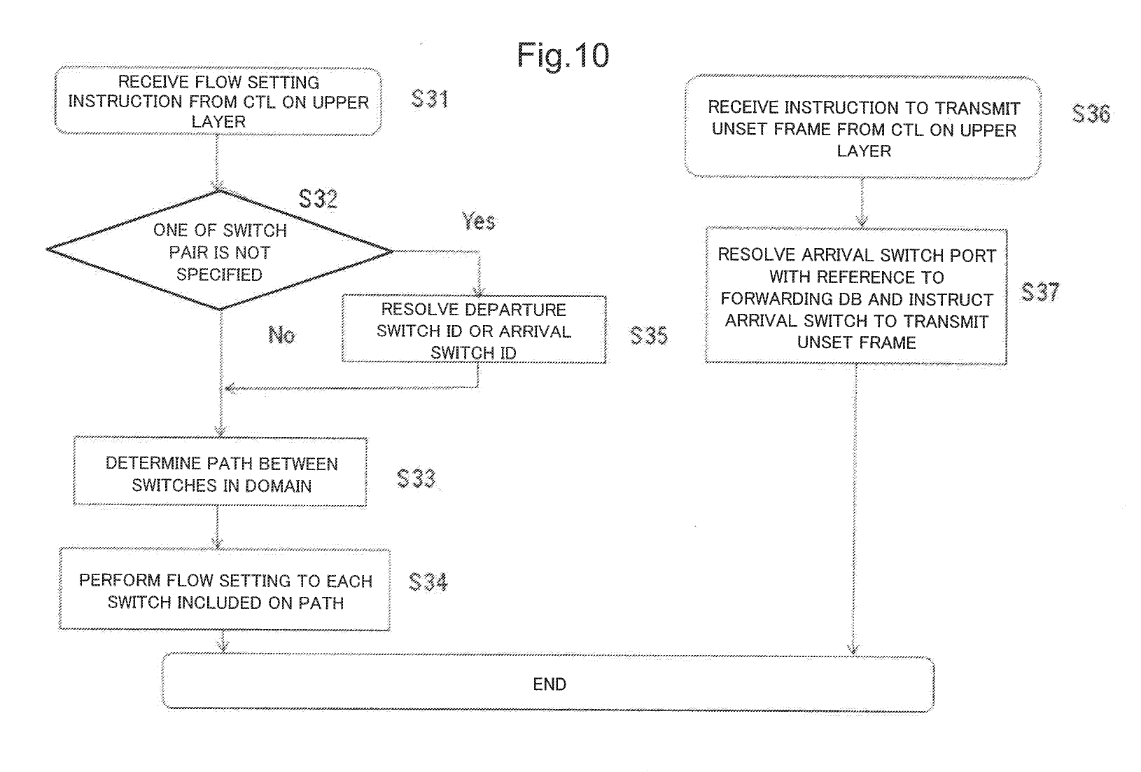

FIG. 9 and FIG. 10 are flow diagrams illustrating one example of an operation of the control apparatus 5 (FIG. 3) installed in the lowest layer in the present exemplary embodiment.

Referring to FIG. 9, the control apparatus 5, when the unset frame is received from the departure switch (step S21), registers a pair of the destination address in the unset frame information and a port from which the departure switch has received the unset frame in the forwarding DB 6 (step S22).

Next, the control apparatus 5 refers to the destination address, and examines whether the destination address is in its own domain or not (step S23). When the destination address is in its own domain (Yes in step S23), the control apparatus 5 proceeds to step S24. On the other hand, when the domain of the destination address is not in its own domain (No in step S23), the control apparatus 5 transmits the unset frame information to the control apparatus in the upper layer (step S29).

Next, the control apparatus 5 refers to the forwarding DB 6, and examines whether there is the switch port corresponding to the destination address (step S24). When the switch port corresponding to the destination address is not in the forwarding DB 6 (No in step S24), the control apparatus 5 proceeds to step S28. On the other hand, when the switch port corresponding to the destination address is in the forwarding DB 6 (Yes in step S24), the path determination means 12 of the control apparatus 5 refers to the internal-domain topology DB 14, and determines the path between the departure/arrival switches (step S25).

Next, the control apparatus 5 instructs each switch on the path to perform flow setting (step S26). The control apparatus 5 instructs the arrival switch to transmit the unset frame (step S27).

In step S28, the control apparatus 5 floods the unset frame in the domain from the switch connected to the control apparatus 5 to another switch by using a preset minimum spanning tree. Each switch forwards the unset frame to all ports other than the port accommodating the transmission terminal.

In step S29, the control apparatus 5 forwards the unset frame to the control apparatus in the upper layer.

In FIG. 10, steps S31 to S35 when a flow setting instruction is received from the control apparatus in the upper layer by specifying the switch pair are similar to steps S82 to S86 illustrated in FIG. 7. Referring to FIG. 10, the control apparatus 5, when the instruction to transmit the unset frame is received from the control apparatus in the upper layer (step S36), resolves the arrival switch port by referring to the forwarding DB 6, and instructs the arrival switch to transmit the unset frame (step S37).

In the present exemplary embodiment, an address of a terminal includes the identifier identifying the domain. By this, a range of broadcasting of the unset frame can be limited within the arrival domain, and it is possible to reduce such a load applied to the forwarding system such as a switch or a link.

### Example 1

Next, a first Example (referred to as “Example 1”) of the network system according to the first exemplary embodiment will be described with reference to drawings.

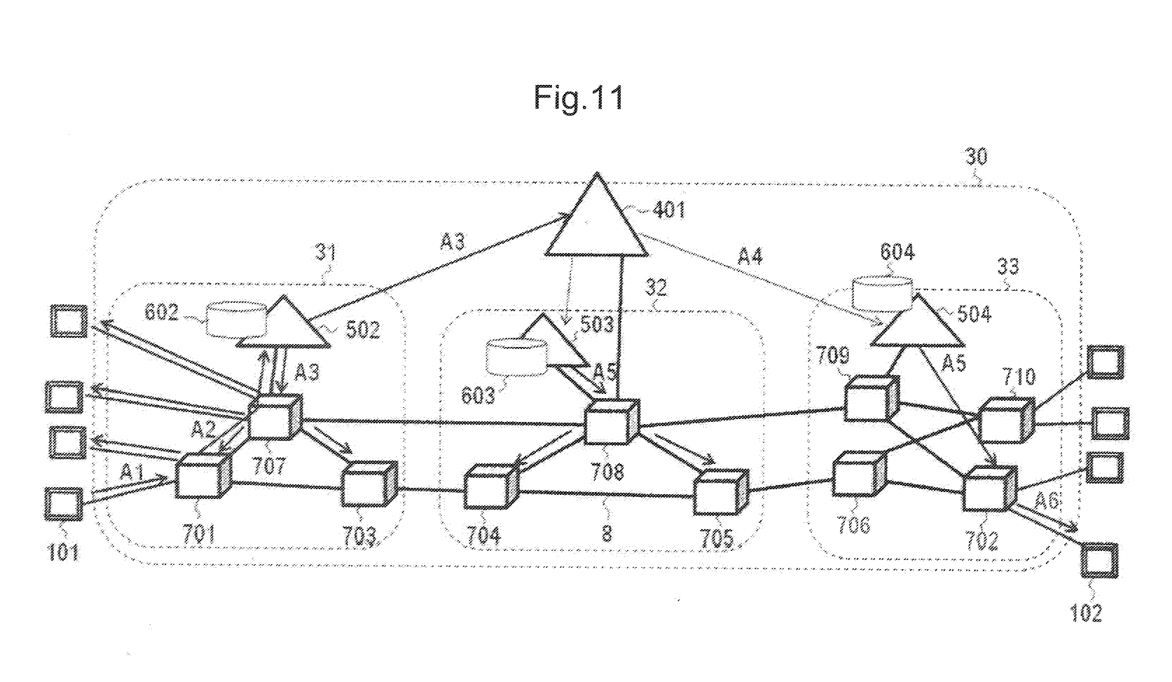

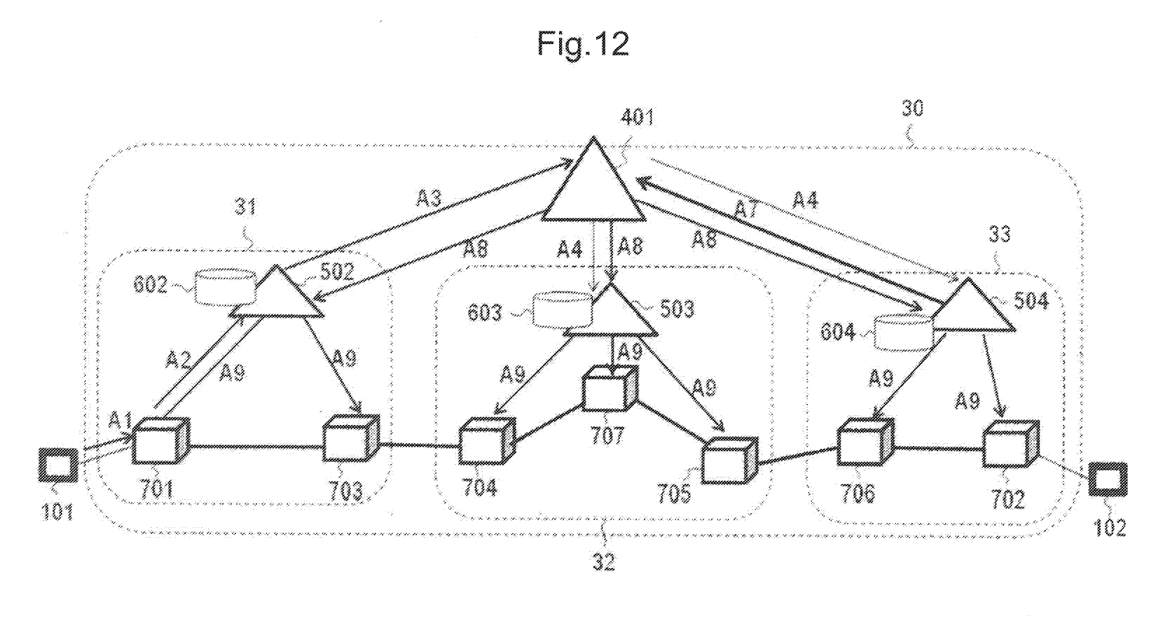

FIG. 11 and FIG. 12 are diagrams illustrating an operation of the control apparatus and the switch when a flow is set between switches each accommodating transmission/reception terminals in a network in which the control system is layered in two layers.

Referring to FIG. 11, an identifier “30” is provided to the domain of the whole network system. The domain 30 is further divided into three domains to which identifiers “31”, “32”, and “33” are provided. These three domains 31 to 33 constitute the lower layer. In the domain 30 in the upper layer, a control apparatus 401 is installed. On the other hand, in the domains 31 to 33 in the lower layer, control apparatuses 502 to 504 are installed, respectively.

To the control apparatuses 502 to 504 of the lower layer, forwarding DBs 602 to 604 are provided, respectively.

Here, it is supposed that a frame to a terminal 102 connected to a switch 702 is forwarded from a transmission source terminal 101 to a switch 701 for the first time (step A1).

Since a flow between the transmission source terminal 101 and the destination terminal 102 is not set, the switch 701 forwards an unset frame to the control apparatus 502 of the domain 31 (step A2).

The control apparatus 502 refers to the forwarding DB 602, and forwards an unset frame information (including the departure domain identifier 31 and the unset frame) to the control apparatus 401 in the upper domain 30 since the address of the destination terminal 102 is not registered (step A3). The control apparatus 502 broadcasts the unset frame to all switches 701, 703, and 707 in the domain by using a spanning tree having the switch 707 as a root. Further, each switch which has received the unset frame forwards the unset frame to all terminals accommodated by the switch other than the departure terminal 101.

The control apparatus 401 forwards the unset frame to adjacent control apparatuses 503, 504 other than the control apparatus 502 which is the transmission source of the unset frame (step A4).

The control apparatus 504 refers to the forwarding DB 604, and forwards the unset frame to the switch 702 since the switch 702 and the identifier of its port accommodating the terminal 102 are registered for the address of the destination terminal 102 (step A5). The control apparatus 503 broadcasts the unset frame to all switches 704, 705, and 708 in the domain by using a spanning tree having the switch 708 as a root. Further, each switch which has received the unset frame forwards the unset frame to all terminals accommodated by the switch.

The switch 702 forwards the unset frame to the terminal 102 (step A6).

Referring to FIG. 12, the control apparatus 504 which has received the unset frame in step A4 resolves the identifier of the switch port to the destination address included in the unset frame by referring to the forwarding DB 604. Since the identifier of the switch port to the destination address can be resolved, the control apparatus 504 transmits the address resolution response to the upper control apparatus 401 (step A7). Here, the address resolution response includes the departure domain identifier 31, the arrival domain identifier 33, and the header field related to the unset frame.

The control apparatus 401 determines, from the departure domain identifier 31 and the arrival domain identifier 33, that the departure domain and the arrival domain are included in their own domain 30. The control apparatus 401 then calculates the path from the domain 31 to the domain 33. The control apparatus 401 instructs the control apparatuses 502, 503, 504 of the domains 31, 32, 33 on the path to perform flow setting by specifying (*, 703), (704, 705), (706, *), respectively as border switch pairs (step A8). Here, “*” indicates “not specified”.

Next, the control apparatuses 502 to 504 respectively calculate the path between specified switches, and set the flow to switches on the path (step A9). The control apparatus 502 refers to the forwarding DB 602 to resolve the corresponding departure switch 701 from the header field, and performs the above-described process between the switches (701, 703). Likewise, the control apparatus 504 refers to the forwarding DB 604 to resolve the corresponding arrival switch 702 from the header field, and performs the above-described process between the switches (706, 702).

### Example 2

Next, a second Example (referred to as “Example 2”) of the network system according to the first exemplary embodiment will be described with reference to drawings.

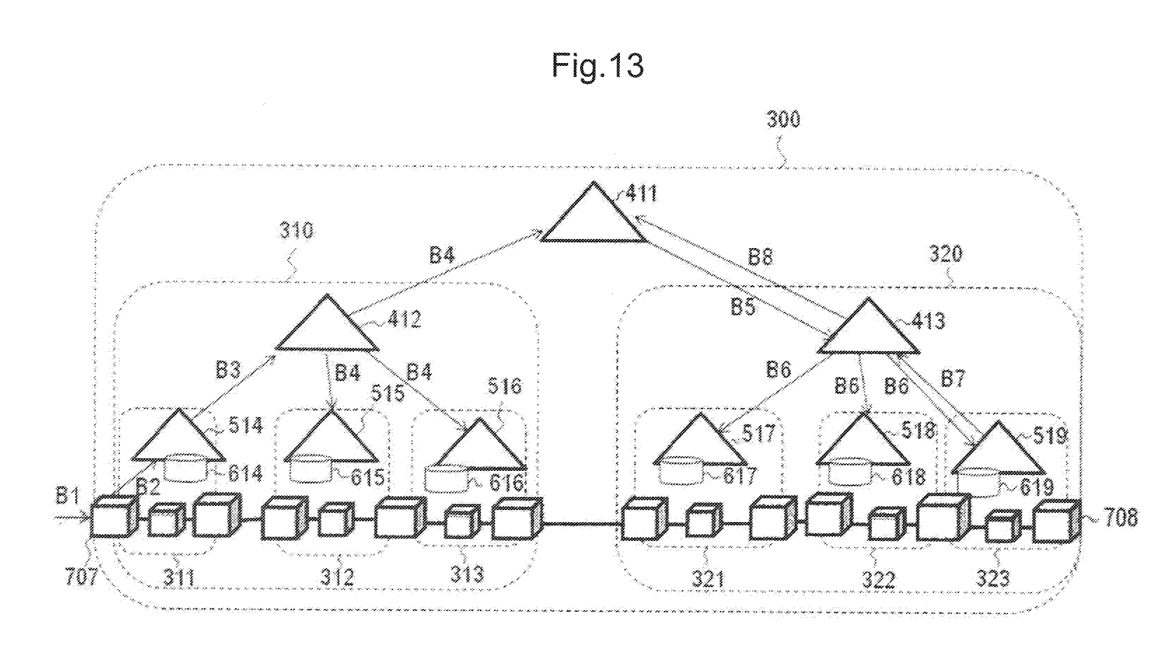

FIG. 13 is a diagram illustrating an operation to determine the top control apparatus that performs a flow setting instruction in the network in which a control system is layered in three layers.

Referring to FIG. 13, a domain identifier “300” is provided to a domain of the whole system. The domain 300 is divided into a domain 310 and a domain 320. The domain 310 is divided into domains 311 to 313 in the lowest layer. Likewise, the domain 320 is divided into domains 321 to 323 in the lowest layer.

In the domain 300 in the top layer, a control apparatus 411 is installed. In the domains 310, 320 in an intermediate layer, control apparatuses 412, 413 are installed, respectively. Further, in the domains 311 to 313, 321 to 323 in the lower layer, control apparatuses 514 to 519 are installed.

To the control apparatuses 514 to 519 in the lower layer, forwarding DBs 614 to 619 are provided, respectively.

First, a transmission terminal (not illustrated) transmits a frame to a switch 707 (step B1).

Next, the switch 707, because of no flow setting, forwards an unset frame to the control apparatus 514 (step B2).

Next, since the control apparatus 514 cannot resolve the switch port from the destination address based on the forwarding DB 614, the control apparatus 514 transmits the unset frame with the departure domain identifier 311 to the control apparatus 412 in the upper layer (step B3).

Next, when the control apparatus 412 receives the unset frame, the control apparatus 412 forwards the received unset frame information to the other adjacent control apparatuses 515, 516 and control apparatus 411 (step B4).

Next, when the control apparatus 411 receives the unset frame information, the control apparatus 411 forwards the received unset frame information to the other adjacent control apparatus 413 (step B5).

Next, when the control apparatus 413 receives the unset frame information, the control apparatus 413 forwards the received unset frame information to the other adjacent control apparatuses 517 to 519 (step B6).

Next, the control apparatus 519 resolves the switch port for the destination address included in the received unset frame information. Since the switch port is resolved, the control apparatus 519 transmits the address resolution response to the control apparatus 413 in the upper layer (step B7). Here, the address resolution response includes the departure domain 311, the arrival domain 323, and the header field of the unset frame.

Since the departure domain 311 is not included in the own domain 320, the control apparatus 413 forwards the address resolution response to the control apparatus 411 in the upper layer (step B8).

Upon reception of the address resolution response, the control apparatus 411 starts the flow setting operation since the departure domain 311 is included in the own domain 300.

In the present Example, a case in which the network is layered in three layers is described as one example. However, the network system according to the first exemplary embodiment can be applied to a network system including a control system which is layered in four or more layers.

### Example 3

Next, a first Example (referred to as “Example 3”) of the network system according to the second exemplary embodiment will be described with reference to drawings.

FIG. 14 is a diagram illustrating an operation of a control apparatus and a switch when a flow is set between switches each accommodating transmission/reception terminals in a network in which a control system is layered in two layers.

Referring to FIG. 14, an identifier “30” is provided to a domain of the whole network system. The domain 30 is further divided into three domains to which identifiers “31”, “32”, and “33” are provided. These three domains 31 to 33 constitute a lower layer. In the domain 30 in the upper layer, a control apparatus 401 is installed. On the other hand, in the domains 31 to 33 in the lower layer, control apparatuses 502 to 504 are installed, respectively. In the addresses of the terminals 101, 102, an identifier of the domain to which a switch accommodating each of these terminals belongs is embedded.

A frame to a terminal 102 connected to a switch 702 is forwarded from the transmission source terminal 101 to the switch 701 for the first time (step C1).

Since the path for the flow defined by the pair of addresses of the transmission/reception terminals 101, 102 is not set, the switch 701 forwards the unset frame to the control apparatus 502 in the domain 31 (step C2).

The control apparatus 502 refers to the forwarding DB 602, and forwards the unset frame to the control apparatus 401 in the upper domain 30 since the address of the destination terminal 102 is not its own domain and is not registered (step C3).

The control apparatus 401 refers to the unset frame to grasp that an arrival domain is the domain 33, and forwards the unset frame only to the control apparatus 504 provided to the domain 33 (step C4).

The control apparatus 504 refers to the forwarding DB 604 to determine the switch 702 corresponding to the destination address and its port, and forwards the unset frame to the switch 702 (step C5).

The switch 702 forwards the received unset frame to the reception terminal 102 (step C6).

After the step C3, the control apparatus 401 determines that the domain identifier 33 included in the destination address of the unset frame is included in its own domain 30, and calculates the path from the departure domain 31 to the arrival domain 33. Next, the control apparatus 401 instructs the control apparatuses 502, 503, 504 which are installed in the domains 31, 32, 33 on the path, respectively to perform flow setting by specifying (*, 703), (704, 705), (706, *), respectively as border switch pairs (step C7). Here, “*” indicates “not specified”.

The control apparatuses 502 to 504 respectively calculate the path between specified switches, and set the flow to switches on the path (step C8). The control apparatus 502 refers to the forwarding DB 602 to resolve the corresponding departure switch 701 from the header field of the departure address, and performs the above-described process between the switches (701, 703). Likewise, the control apparatus 504 refers to the forwarding DB 604 to resolve the corresponding arrival switch 702 from the header field of the arrival address, and performs the above-described process between the switches (706, 702).

### Example 4

Next, a second Example (referred to as “Example 4”) of the network system according to the second exemplary embodiment will be described with reference to drawings.

FIG. 15 is a diagram illustrating an operation to determine a top control apparatus that performs a flow setting instruction in a network in which a control system is layered in three layers and a MAC address of a terminal includes a domain identifier.

A configuration of the layered domain of the network of the present Example is similar to the configuration in Example 2 (FIG. 13).

First, a transmission terminal (not illustrated) transmits a frame to a switch 707 (step D1).

Next, the switch 707, because of no flow setting, forwards the unset frame to the control apparatus 514 (step D2).

Next, since the destination address is not in its own domain and the switch port cannot be resolved from the departure address by referring to the forwarding DB 614, the control apparatus 514 forwards the unset frame to the control apparatus 412 of the upper layer (step D3).

Next, the control apparatus 412 refers to the destination address to determine that the domain 323 to which the destination address belongs is not included in its own domain 310, and forwards the received unset frame to the control apparatus 411 in the upper layer (step D4).

Next, the control apparatus 411 refers to the destination address to determine that the domain 323 including the switch accommodating the terminal to which the destination address is provided is included in its own domain, and starts the flow setting operation.

In the present Example, a case in which a network is layered in three layers is described as one example. However, the network system according to the second exemplary embodiment can be applied to a network system including a control system which is layered in four or more layers.

The above-described patent literatures and non patent literatures are hereby incorporated by reference in their entirety. Within the scope of the entire disclosure (including claims) of the present invention, and in addition, on the basis of the basic technical ideas, the exemplary embodiments can be changed and modified. Moreover, within the scope of claims of the present invention, various combinations or selections of various disclosed elements (including each element of each claim, each element of each exemplary embodiment, each element of each drawing and the like) are possible. More specifically, it is apparent that the present invention includes various modifications and changes that can be made by those skilled in the art according to all disclosure including claims, and the technical ideas. In particular, regarding the value range described herein, any value or small range included in the range should be interpreted as being specifically described even when there is no particular description.

### REFERENCE SINGS LIST

2 FORWARDING NETWORK
4, 5 CONTROL APPARATUS
6 FORWARDING DB
8 LINK
9 INPUT/OUTPUT UNIT
10 PATH SETTING MEANS
11 FLOW SETTING MEANS
12 PATH DETERMINATION MEANS
13 INTER-DOMAIN TOPOLOGY DB
14 INTERNAL-DOMAIN TOPOLOGY DB
15 ADJACENT CONTROL APPARATUS DB
30, 31 TO 33 DOMAIN
40, 51 TO 53 CONTROL APPARATUS
60 FORWARDING DB
101, 102 TERMINAL
300, 310, 311 TO 313, 321 TO 323, 320 DOMAIN
401, 411 TO 413, 502 TO 504, 514 TO 519 CONTROL APPARATUS
602 TO 604, 614 TO 619 FORWARDING DB
701 TO 710, A TO J SWITCH

What is claimed is:

1. A network system comprising:
a switch;
a link connecting switches;
a plurality of first control apparatuses that are provided to a plurality of first domains respectively when the network system is divided into the plurality of first domains and control the switch included in the plurality of first domains respectively,
each
include a database holding an address of a terminal and an identifier of a switch port accommodating the terminal associated with each other, the address of the terminal including an identifier of the first domain to which the switch accommodating the terminal to which the address is provided belongs,
upon reception of a frame for which a path is not set from the switch included in an own domain of the first control apparatus, determine whether a destination address of the frame belongs to the own domain of the first control apparatus or not, and
when the destination address does not belongs to the own domain of the first control apparatus, forward the frame to a second control apparatus; and
the second control apparatus that is provided to a second domain that is an aggregation of the plurality of first domains and controls the plurality of first control apparatuses.

2. The network system according to claim 1, wherein the plurality of first control apparatuses each, when the destination address of the frame belongs to the own domain of the first control apparatus and the switch port to which the frame to be forwarded cannot be resolved from the destination address based on the database, forward the frame to the switch included in the own domain of the first control apparatus.

3. The network system according to claim 1, wherein,
the second control apparatus, upon reception of the frame from the first control apparatus, identifies an arrival domain of the frame based on the destination address of the frame, forwards the frame to the first control apparatus provided to the identified arrival domain, determines a path between the first domain corresponding to a departure domain identified based on a source address of the frame and the first domain corresponding to the arrival domain, and instructs the first control apparatus provided to the first domain on the determined path to perform path setting.

4. The network system according to claim 1, further comprising a third control apparatus that is provided to a third domain that is an aggregation of a plurality of the second domains and controls the plurality of the second control apparatuses, wherein,
the plurality of the second control apparatuses each, upon reception of the frame from the first control apparatus, identify the arrival domain of the frame based on the destination address of the frame, determine whether the identified arrival domain belongs to an own domain of the second control apparatus or not, and when the identified arrival domain does not belong to the own domain of the second control apparatus, forward the frame to the third control apparatus.

5. The network system according to claim 4, wherein,
the third control apparatus, upon reception of the frame from the second control apparatus, identifies the arrival domain of the frame based on the destination address of the frame, forwards the frame to the second control apparatus provided to the second domain to which the identified arrival domain belongs, determines a path between the second domain to which the departure domain belongs identified based on the source address of the frame and the second domain to which the arrival domain belongs, and instructs the second control apparatus provided to the second domain on the determined path to perform path setting.

6-9. (canceled)

10. A control method for a first control apparatus that is provided to one of a plurality of first domains when a network system including a switch and a link connecting switches is divided into the plurality of first domains and controls the switch included in the first domain, the method comprising:
holding an address of a terminal and an identifier of a switch port accommodating the terminal associated with each other, the address of the terminal including an identifier of the first domain to which the switch accommodating the terminal to which the address is provided belongs;
determining, upon reception of a frame for which a path is not set from the switch included in an own domain of the first control apparatus, whether a destination address of the frame belongs to the own domain of the first control apparatus or not; and
forwarding, when the destination address does not belongs to the own domain of the first control apparatus, the frame to a second control apparatus that is provided to a second domain that is an aggregation of the plurality of first domains and controls the plurality of first control apparatuses.

11. The control method according to claim 10, further comprising forwarding, when the destination address of the frame belongs to the own domain of the first control apparatus and the switch port to which the frame to be forwarded cannot be resolved from the destination address based on the database, the frame to the switch included in the own domain of the first control apparatus.

12. A non-transitory computer readable medium recording thereon a program, causing a computer for a first control apparatus that is provided to one of a plurality of first domains when a network system including a switch and a link connecting switches is divided into the plurality of first domains and controls the switch included in the first domain to perform a method comprising:
holding an address of a terminal and an identifier of a switch port accommodating the terminal associated with each other;
determining, upon reception of a frame for which a path is not set from the switch included in an own domain of the first control apparatus, whether a destination address of the frame belongs to the own domain of the first control apparatus or not; and
forwarding, when the destination address does not belongs to the own domain of the first control apparatus, the frame to a second control apparatus that is provided to a second domain that is an aggregation of the plurality of first domains and controls the plurality of first control apparatuses, wherein
the address of the terminal including an identifier of the first domain to which the switch accommodating the terminal to which the address is provided belongs.

13. The non-transitory computer readable medium recording thereon the program according to claim 12, the method further comprising forwarding, when the destination address of the frame belongs to the own domain of the first control apparatus and the switch port to which the frame to be forwarded cannot be resolved from the destination address based on the database, the frame to the switch included in the own domain of the first control apparatus.
